(19) United States
(12) Patent Application Publication
(10) Pub. No.: US 2005/0185300 A1
(43) Pub. Date: Aug. 25, 2005

(54) Optical arrangement with stepped lens

(75) Inventors: Rudiger Kittelmann, Einbeck (DE); Harry Wagener, Alfeld (DE)

Correspondence Address: Charles N.J. Ruggiero, Esq.;Ohlandt, Greeley, Ruggiero & Perle, L.L.P., 10th Floor, One Landmark Square, Stamford, CT, 06901-2682, US

(73) Assignee: Schott AG

(21) Appl. No.: 11/006,473

(22) Filed: Dec. 7, 2004

(30) Foreign Application Priority Data
Dec. 22, 2003 (DE) 103 61 121.5-51

(51) Int. Cl. G02B 3/08

(52) U.S. Cl. 359/742

(57) ABSTRACT

In order to provide an optical arrangement having a Fresnel or stepped lens such that its optical properties can be configured more diversely, provision is made of a diffusing screen, preferably with an adapted predefined diffusing behavior.

The invention relates to an optical arrangement with at least one stepped lens.

Stepped or Fresnel lenses go back to the French physicist Augustin Jean Fresnel, who created this optical element, which is also referred to as an annular lens, back in the nineteenth century. In contrast to the optical lenses with a solid body that are otherwise used, stepped or Fresnel lenses have concentric steps which are arranged essentially perpendicular to the principle plane of the lens and between which annular segments are situated. The shape of the optically effective surfaces of the annular segments approximately corresponds to the shape of surface segments of a normal lens with a solid body, but said surfaces lie substantially nearer to the opposite surface of the respective lens. Furthermore, the optically essentially noneffective areas of the steps are arranged as far as possible parallel to the main direction of light propagation in order to generate the smallest possible reflections or little undesirable scattered light. Therefore, to an approximation, except for disturbances caused by the steps, a Fresnel lens has similar imaging properties to a normal lens. Despite said disturbances, however, the Fresnel lens has significant advantages over conventional lenses which make this type of lens the distinctly preferred or else only possible choice in many applications. Fresnel lenses have a smaller thickness, require less optical material, are consequently lighter and have a lower absorption and thus also less heating-up particularly when they are used in lighting devices with high light intensities.

Fresnel lenses are used highly advantageously for example in stepped spotlights for theatre, stage, studio, film or else for architectonic illumination.

The smaller thickness of the Fresnel lenses also means, however, that they are often substantially simpler to produce. For embossing, injection molding or hot-forming, a thinner Fresnel lens can be controlled significantly better in terms of its cooling-down and mold-release behavior than its counterpart with a solid volume. These advantages gain in importance as the size of said lenses increases. Consequently, preferred areas of application are illumination technology, in particular in the theatre, studio, in particular for film, on the stage and in architecture, where a high quantity of light frequently also entails a high thermal loading but disturbances of the imaging properties are of lesser significance.

A stepped lens with a centrally arranged, parallel prism arrangement that directs the light preferably into the lower half-space is known from the signaling technology of rail-borne traffic, this being used to provide part of the light that enters the stepped lens for signal discernability in the near range.

The invention is based on the object of further improving the usability of a stepped lens, in particular for lighting applications.

This object is achieved in a surprisingly simple manner by means of the features of claim 1.

With the light-diffusing element according to the invention, in particular a diffusing screen, it is possible to obtain an additional degree of freedom in the construction of optical properties.

The combination of geometrical-optical imaging of the stepped lens with a scattering lobe—superposed thereon—of the light scattered at the diffusing screen permit illumination light distributions that are of great interest in terms of lighting. Thus, not only is it possible to suppress the light source or luminous body image, but it is even possible to greatly reduce or avoid faults of illuminating beam paths given a suitable choice of the diffusing structure and the geometrical dimensioning thereof.

An application of particular interest is found in the case of reflector arrangements with a relatively small light source in relation to their holder, such as, for example, a high-pressure discharge lamp having emission ranges of the order of magnitude of a few millimeters and distinctly larger holder diameters. In the case of light sources of this type, the central light field can be darkened by virtue of the fact that the holder passing through the reflector requires an opening within the reflector which is distinctly larger than the light source and light beams thus cannot be reflected near the optical axis within said opening. By virtue of a suitable choice of the forward scattering lobe of the light-diffusing device, preferably a circular central diffusing screen, it is possible, surprisingly, essentially to retain the geometrically optical properties of the stepped lens and a central intensity decrease can nevertheless be avoided.

In this case, the optical arrangement is advantageously formed in one piece, in order that both the stepped lens and the diffusing screen are produced in a single embossing operation expediently in terms of production engineering.

The stepped lens is preferably an aspherical lens, in order to compensate for spherical aberrations and to attain the best possible imaging performance.

If the stepped lens has a basic body with an optically beam-shapingly effective, essentially concave surface, it is thereby possible to take account of more complex optical requirements since this makes it possible to define concave-convex or biconcave lenses, for example, in which the stepped lens and also the basic body thereof become geometrically-optically effective.

Furthermore, the stepped lens may have a basic body with an essentially convex surface, in order thus to create convex-concave or biconvex lenses.

To an approximation, the shape of the basic body may be utilized independently in optically beam-shaping fashion and the beam-shaping properties of the stepped lens may be utilized in combination or in superposed fashion.

In this case, the basic body of the stepped lens is understood to be that part which would result if the steps of the stepped lens were removed therefrom; this means the volume material on which the steps of the stepped lens are applied or into which said steps are impressed.

It is thus possible, in terms of production engineering, firstly to calculate the shape of the desired stepped lens and to attain additional optical beam-shaping properties by means of the further configuration of the basic body, preferably in planoconcave, planoconvex, biconcave, biconvex or concave-convex form.

If the essentially annular, optically effective surfaces of the steps are configured as circle-arc surface segments, it is possible to utilize geometries which are simple to realize in terms of production engineering and which nevertheless still have relatively good optical properties.

In a simple, cost-effective embodiment, the essentially annular, optically effective surfaces of the steps are formed in the shape of cone envelopes.

However, the optimum optical imaging performance is achieved essentially in the case of a converging stepped lens, thus a lens with a positive focal length and a real focal point, if the essentially annular, optically effective surfaces of the respective steps are shaped such that an approximately planar wave with phase fronts perpendicular to the optical axis leaves the lens when light originating from a single real focal point enters said lens. In the case of a diffusing lens, thus a lens with a negative focal length and a virtual focal point, the optimum is achieved when the light of a planar wave which enters the stepped lens is converted into a spherical wave whose midpoint appears to originate from a single virtual focal point.

In a particularly preferred embodiment, the diffusing screen is arranged only in a central region of the stepped lens and preferably on the side of the steps, since this embodiment can already be produced by means of a single hot-forming step with high precision.

It is highly advantageous if the diffusing screen is arranged in delimited fashion in a centric region of the stepped lens, since it is then possible, by this means, to generate a surprisingly variable intensity distribution in the case of lighting illumination devices. Thus, by way of example, through the use of diaphragms or through changed focusing of the entering light field, it is possible to change the diameter thereof and to create a variably adjustable transition from scattered to geometrically-optically imaged light. As long as only light impinges on the inner diffusing screen, the properties thereof define the shape of the emerging and illuminating light field. If geometrical-optical imaging properties increasingly arise when the diameter of the light field is enlarged, it is possible, by way of example, to achieve a highly uniform enlargement of the illuminating light cone.

An even more continuous and smoother transition in the light distribution to be changed can be achieved if the light-diffusing element has regions that diffuse to different extents, preferably a region that diffuses to a greater extent centrically and a region that diffuses to a lesser extent marginally.

Depending on the material of the diffusing screen, the latter is preferably produced in a manner adapted to its diffusing behavior by hot-forming, in particular embossing, and/or injection molding.

Preferred materials for the stepped lens and/or the diffusing screen are glass and glass-ceramic materials. The high resistance to alternating temperatures is particularly advantageous in the case of glass ceramics.

Furthermore, the optical arrangement with stepped lens and diffusing screen may be composed of a plurality of elements in order, by way of example, to utilize different production methods and the advantages thereof.

Thus, an, in particular embossed, plastic stepped lens may be connected to a diffusing screen consisting of glass, thus resulting in a hybrid composite made of glass and plastic.

If the stepped lens comprises a material with a first dispersion behavior, and a further lens with an opposite refractive power, preferably a stepped lens, with a material with a second dispersion behavior, it is even possible to create chromatically corrected or achromatic lens systems.

Optical path length in the sense of this description is regarded as the wavelength of a central region of the light spectrum respectively used.

If the stepped lens is an embossed plastic lens, it may be highly advantageous if this lens has an optical path length difference at the respective step of less than about 1000 optical wavelengths, since it is then possible generally to realize a relatively flat stepped lens which causes only small disturbances of the geometrical-optical light propagation.

Furthermore, in the case of locally high light intensities, it may be highly practical, depending on the construction, to depart from the conventional use of gelatin filters, which, in the region of strong light intensity, such as in the vicinity of real focal points, for example, can rapidly bleach or even melt and ignite, and instead to use coated or colored glasses.

Thus, if the stepped lens and/or the diffusing screen are/is formed as a filter, in particular as a V, IR or colored bandpass filter and/or conversion filter, it is possible to provide very much more reliable and more exact filtering of the light. Furthermore, it lies within the scope of this configuration to produce sets of optical arrangements which, preferably with dichroic or interference filter layers, are coordinated with defined light temperatures for defined light sources.

Thus, by way of example, a defined color shift in the direction of lower color temperature values may impart to a high-pressure discharge lamp the spectrum of a black body radiator, such as an incandescent lamp, for example.

Furthermore, spectrally predominant bands of excited discharge lines can be moderated in a defined manner and a more homogenous spectral distribution can thus be achieved.

In addition, with filter arrangements of this type, for predetermined spectra of light sources, it is also possible to simulate lighting atmospheres in the spectral distribution thereof, such as, for example, early morning light, evening light, storm or thunderstorm light, so that most requirements appertaining to studio, theatre, film and architecture can be met by means of a single light source and an assigned set of optical arrangements according to the invention.

Since dichroic or interference filters permanently withstand high radiation intensities with a high degree of spectral precision, these filters, depending on the application, may not only be spectrally better but, due to their long lifetime, may also be less expensive than conventional color filter sheets. Furthermore, harsh ambient conditions, such as in the case of architecture illumination or in the case of outdoor recordings, for example, are a further reason for using optical arrangements of this type.

When using plastic lenses and/or diffusing screens, it is particularly advantageous if these are coated with a mechanical antiscratch layer.

Furthermore, undesirable reflections, in particular at the stepped areas, may not only lead to the loss of light from the main luminous flux, but brighter circles or points may even be formed in the illumination plane, which can be greatly reduced or even suppressed by means of an antireflection layer on said stepped areas.

The invention is explained in more detail below using preferred exemplary embodiments and with reference to the accompanying drawings.

In the figures:

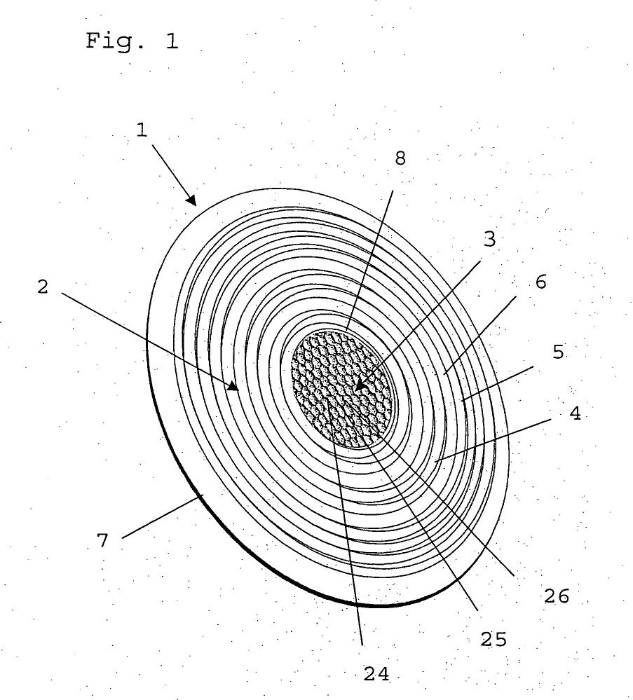

FIG. 1 shows a first embodiment of the optical arrangement of a stepped lens with an approximately centrically arranged, essentially circular diffusing screen which has individual facets that are slightly rotated with respect to one another,

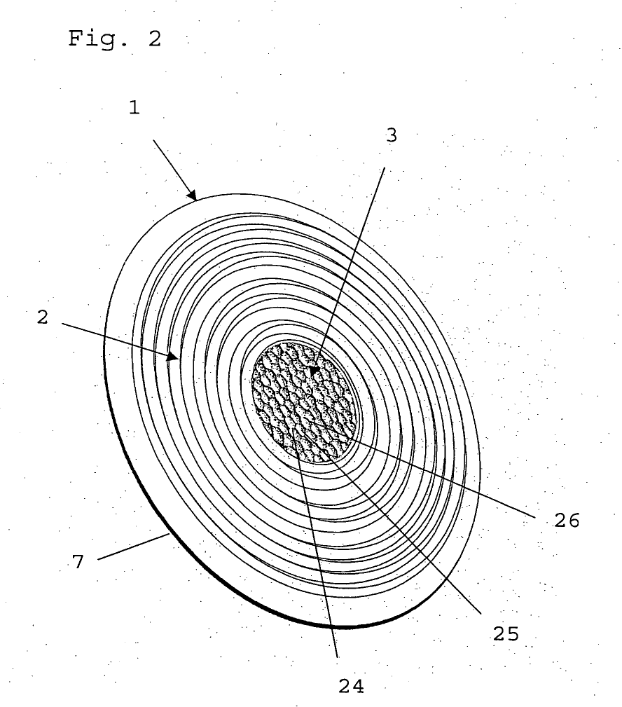

FIG. 2 shows a second embodiment of the optical arrangement of a stepped lens with an approximately centrically arranged, essentially circular diffusing screen which has facets which have been offset from their regular position by means of a Monte Carlo method,

FIG. 3 shows a third embodiment of a stepped lens with an approximately centrically arranged, essentially circular diffusing screen, in the case of which the individual facets of the diffusing screen lie on an Archimedes' spiral,

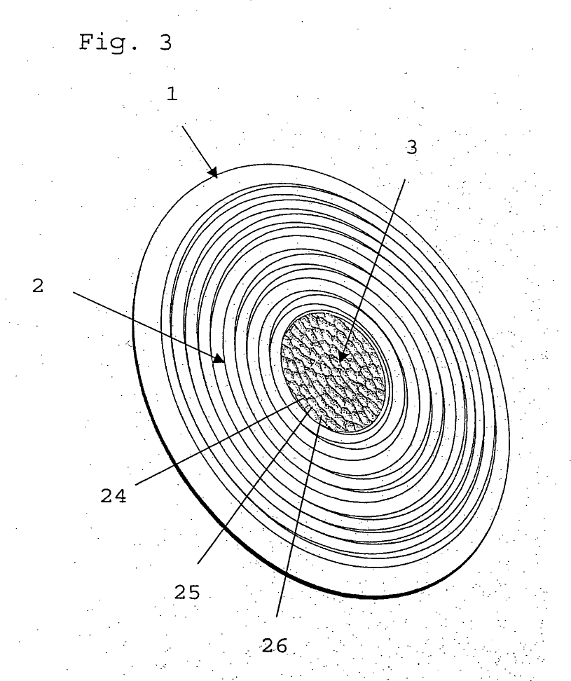

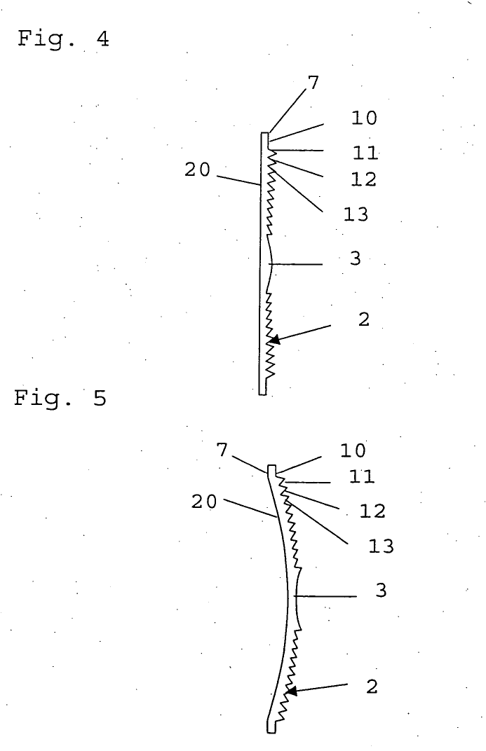

FIG. 4 shows a cross section through a planoconvex lens with a central diffusing screen, the basic body of which is formed in essentially plane fashion and the stepped lens of which is formed in convex fashion,

FIG. 5 shows a cross section through a biconcave stepped lens arrangement which has geometrical-optical beam-expanding or light-diffusing properties and in the case of which both the basic body and its geometrically-optically effective stepped lens system are essentially configured in concave fashion,

FIG. 6 shows an enlargement of a detail of an upper segment of the cross-sectional illustration of FIG. 4,

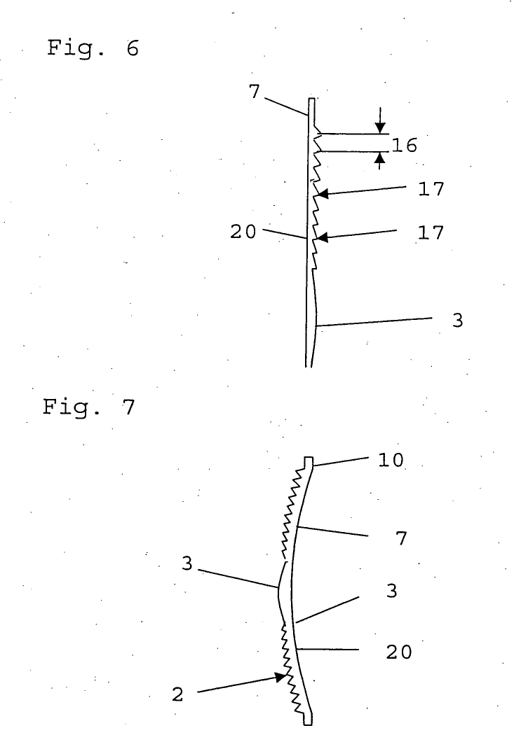

FIG. 7 shows a cross-sectional illustration of a convex-concave stepped lens arrangement whose basic body is configured in concave fashion and whose geometrically-optically effective stepped lens system is essentially configured in convex fashion,

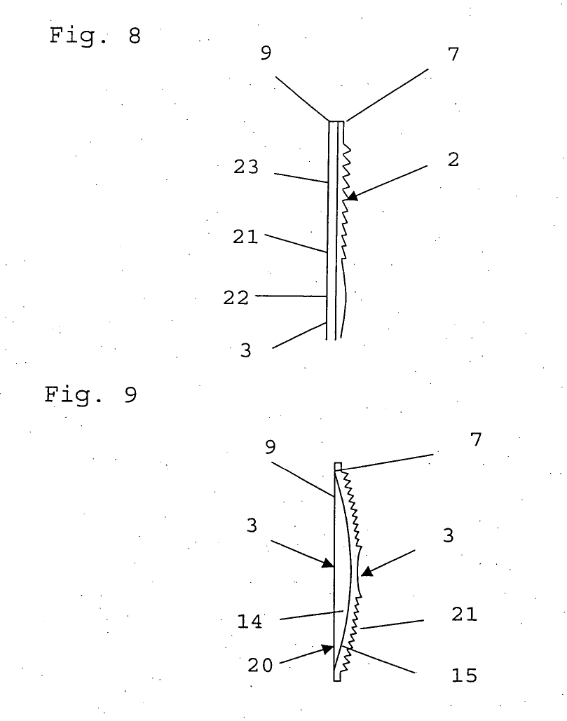

FIG. 8 shows a cross-sectional illustration of a hybrid lens arrangement comprising an embossed planoconvex plastic stepped lens arrangement fitted to a diffusing screen consisting of glass,

FIG. 9 shows a cross-sectional illustration of a hybrid lens achromat in which a planoconvex lens consisting of glass is connected to a biconcave stepped lens consisting of plastic or a glass with a different dispersion.

### DETAILED DESCRIPTION OF PREFERRED EMBODIMENTS

The invention is described in more detail below with reference to preferred embodiments.

This description generally assumes that light entering the lens propagates in a manner coming from the left-hand side toward the right-hand side in the drawings.

Furthermore, in the description of the various embodiments, identical reference symbols are used for identical or essentially identically acting constituent parts of the optical arrangement 1.

Reference is made below to FIG. 1, which shows a first embodiment of the optical arrangement of a stepped lens with an essentially circular diffusing screen which is arranged approximately centrically and has individual facets that are slightly rotated with respect to one another.

The optical arrangement, designated in its entirety by 1, comprises a stepped lens 2 and also a diffusing screen 3 arranged in the central region thereof.

The stepped lens 2 has concentrically arranged, annular steps with optically effective surface regions which are provided with the reference symbol 4, 5 and 6 merely by way of example in FIG. 1.

The diffusing screen 3 illustrated in FIG. 1 and also that illustrated in FIGS. 2 and 3 are by way of example diffusing screens as described in the German Patent Application DE 103 43 630.8 from the same applicant, dated Sep. 19, 2003, entitled “diffusing screen”, the entire content of which is also incorporated into the content of the present disclosure by reference.

In the case of this particularly preferred embodiment, the optical arrangement 1 is produced from an essentially plane basic body 7 in a single hot-forming step, essentially in the case of an embodiment consisting of plastic.

Hereinafter, firstly only the common features of the optical arrangements 1 illustrated in FIGS. 1, 2 and 3 are described and then the respective differences thereof are explained in detail.

The circular diffusing screen 3 is arranged on the light exit side of the basic body 7 and extends over the entire area within the first annular segment 8, which is clearly delimited, and preferably adjoins said screen without any interruption.

In the case of a lens with a real, right-hand-side, thus positive focal point, the basic body 7 is preferably shaped in convex fashion or in outwardly curved fashion in the region of the diffusing screen 3 and also in the region of the annular surfaces 4, 5, 6 and 8, as is shown for example diagrammatically in the cross-sectional illustrations in FIG. 4 and FIG. 6.

In the case of a lens with a virtual or negative, left-hand-side focal point, the basic body 7 is preferably shaped in concave fashion or in inwardly curved fashion in the region of the diffusing screen 3 and also in the region of the annular surfaces 4, 5, 6 and 8, as is shown for example diagrammatically in a cross-sectional illustration in FIG. 5.

However, in particular when using a hybrid lens, which is shown in cross section in FIGS. 8 and 9, the basic body 7 may also be formed in two or more pieces and then comprises both the basic body segment 7 having the stepped lens 2 as well as a further basic body segment 9, which may be formed in planar or plane fashion, as illustrated in FIG. 8, or may be formed in planoconvex fashion, for example, as illustrated in FIG. 9.

Preferably, in the case of hybrid lenses, the basic body segment 9 is produced from glass of a first material and the basic body segment 7 is produced from glass of a second material with a different dispersion than that of the basic body segment 9 or is produced from a hot-formable plastic.

Reference is made hereinafter to FIG. 4 which shows a planoconvex stepped lens with a central diffusing screen 3, and also to FIG. 6, which reproduces a detail from FIG. 4 in an enlarged illustration.

In the case of the stepped lens 2 in one piece illustrated in FIG. 4 and FIG. 5, the respective optically effective surface 11, 12, 13 may be part of an aspherical or else spherical lens and the optical arrangement 1 may have an edge region 10 which may be formed in plane-parallel fashion for mounting in an assigned mechanical receptacle.

As part of an aspherical lens, the annular, optically effective surfaces of said steps (for example 4, 5, 6, 11, 12, 13) are shaped such that an approximately planar wave with phase fronts perpendicular to the optical axis is combined at a real focal point.

In this case, the optical axis is intended to extend through the center of the optical arrangement essentially perpendicular to the principle planes thereof.

In the case of the biconcave stepped lens illustrated in FIG. 5, the respective annular, optically effective surfaces are shaped such that, from a planar wave entering from the left, there are generated the phase fronts of a spherical wave whose virtual focal point or whose apparent origin appears to lie on the optical axis to the left of the stepped lens 2 illustrated in FIG. 5.

It is the case that these geometrical-optical conditions hold true exactly only for one wavelength in a central wavelength range of the light spectrum used.

In order to simplify production, instead of complex aspherical annular geometries, an aspherical lens may also be approximated by spherical ring segments.

In this case, spherical segments that are approximated as well as possible, hence circle-arc surface segments, are used for the respective surfaces of the rings in order to attain simpler production of the required embossing tools.

Another simplification consists for example in utilizing optical surfaces in the shape of cone envelopes for stepped lenses with a very high number of steps and only small respective optical path length differences between edge points of adjacent steps, which surfaces are then only adapted in their inclination to the average inclination of the aspherical lens.

In this case, the individual annular segments and the central circular segment of the stepped lens may be configured either in concave fashion or in convex fashion depending on whether light-converging or light-diffusing properties are desired.

In order to illustrate the extremely variable usability of the concepts according to the invention, FIG. 5 shows a biconcave stepped lens, FIG. 7 shows a convex-concave lens and FIG. 8 and FIG. 9 show hybrid lenses, of which the lens illustrated in FIG. 9 has chromatically corrected properties.

Reference is made below to the hybrid lens which is illustrated in FIG. 9 and in the case of which a planoconvex glass lens 14 with a real focal point on the right-hand side of the lens 14 is connected to a concave-convex diffusing stepped lens 15.

The respective refractive powers or focal lengths and also the refractive indices of the two lenses 14 and 15 are chosen overall such that a converging effect still results. This means that the overall result is a converging lens which a focal point shifted toward the right.

In this case, however, the material of the stepped lens 15 is chosen such that the effect of its dispersion, in the entire arrangement, proceeds counter to the effect of the dispersion of the planoconvex lens 14, so that the overall result is smaller chromatic aberrations for this lens system.

In an alternative configuration, the stepped lens 15 may also consist of an embossed plastic which is laminated onto the lens 14. This plastic lens 15 may be provided with an antiscratch layer 21.

If embossed glass lenses are used, the optical path length difference in the region of the respective step is preferably more than 100 optical wavelengths.

When embossed plastic stepped lenses are used, preferably an optical path length difference at the respective step of less than about 1000 optical wavelengths is preferred.

Furthermore, the annular segments arranged around the central circular segment of the stepped lens may essentially have the same radial extent 16, meaning the same step width 16, see FIG. 6, in particular. Steps of different heights consequently occur in this case, since the angles of inclination of the respective annular, optically active surface segments typically change with increasing distance from the center.

As an alternative, in order to achieve high precision in terms of production engineering in the case of materials that are difficult to shape, the height 17 of the optically effective surface segments may be kept constant, thus resulting in rings with widths of different magnitudes, see FIG. 6, in particular.

Furthermore, the stepped lens 2 and/or the diffusing screen 3 may be formed as a filter, in particular as a UV, IR or colored bandpass filter and/or as a conversion filter.

It is particularly advantageous if, for this purpose, an interference filter layer 20 is applied to one side, as illustrated by way of example on the left-hand side of the planocovex lens 14 in the example in FIG. 9.

As an alternative, this interference filter layer system may also be used for shifting the color temperature or for compensating for spectral lines.

Furthermore, it is particularly advantageous if at least that surface of the optical arrangement 1 which respectively faces a light source consists of glass and is prestressed, preferably thermally prestressed, since this results in a distinctly increased thermal stability.

The diffusing screen 3 may generally be arranged both on the left-hand side, thus the light entry side, and on the right-hand side, thus the light exit side, of the optical arrangement 1.

Furthermore, it is possible, as illustrated merely diagrammatically in FIG. 7, for a diffusing screen 3 to be arranged in each case both on the light entry side and on the light exit side, so that their diffusing effect is superposed in a defined manner.

Furthermore, instead of having a sharp radial boundary, the diffusing screen 3 may also have regions that diffuse to different extents, for example a region that diffuses to a greater extent centrically and a region that diffuses to a lesser extent marginally and preferably runs out continuously.

For this purpose, the diffusing screen may for example have a defined granularity comprising a finer granularity structure in a central region 22 and, with increasing radial distance, a coarser granularity structure in a marginal region 23, also see FIG. 8 for these facts illustrated diagrammatically.

In the case of the embodiments described below of diffusing screens 3 that can be used as an alternative to simple granularities or matted regions, the new approach consists, inter alia, in departing from the regular arrangement of facets of a regular diffusing screen.

This is done, in the case of a first embodiment illustrated in FIG. 1, by providing a diffusing screen 3 having a transparent basic body 7, 9, the optically effective surface of the diffusing screen 3 being subdivided into facets 24, 25, 26, which are provided with reference symbols only by way of example, and each facet 24, 25, 26 being assigned an elevation or depression with a second surface formed in curved fashion, and the facets 24, 25, 26 being arranged such that they are rotated relative to one another, or assuming different geometrical shapes.

In this case, a facet is to be understood to be an area spanned by the edge contour of the respective geometrical shape. Depending on the formation of the first surface, i.e. the surface of the basic body 7 of the diffusing screen 3, as a planar or curved area, the facet 24, 25, 26 spanned by the geometrical shapes may likewise be planar or curved.

The elevation or depression assigned to the facet 24, 25, 26 represents an element of the diffusing screen 3. The elevation or depression has the facet 24, 25, 26 as base area and is situated at least essentially above or below said base area. The elevation or depression may act as a lens in the case of illumination.

This solution results in a superposition of a multiplicity of differently contoured light fields and thus as desired in a round light field.

Depending on the respective facet configuration and the constitution of the elevations or depressions assigned to the facets, it is possible to provide a light field having a selectable gradient of the illumination intensity, or one which emerges predeterminably in soft fashion or hard fashion.

A light field which emerges in soft fashion is one with a small gradient of the illumination intensity toward the edge of the light field. Conversely, a large gradient of the illumination intensity at the edge of the light field results in a light field which emerges in hard fashion. A further advantage achieved is that this facet configuration makes it possible to avoid marginal discolorations when using discharge lamps.

In order to increase the variation of the individual light fields that contribute to the superposition and to achieve the abovementioned advantages by this means, it is possible to implement various measures.

Thus, it may be provided that the facets have a polygonal edge contour. In this case, the number of corners of the polygons is variable.

The facets with a polygonal edge contour should completely cover the surface since otherwise there is no diffusing effect locally.

Furthermore, it is also possible to provide diffusing screens in which the facets 24, 25, 26 contain different areas, as is illustrated by way of example in FIG. 2.

Triangles, quadrangles, pentagons, hexagons and/or heptagons may be chosen as the polygons. The connecting sections between adjacent corners of the polygons may be straight or bent lines.

A further consequence of the irregularity of the facets is that the latter have different orientations.

A further measure that is taken to approach the aim of round light fields, and light fields that emerge in soft fashion or in hard fashion with regard to the illumination intensity toward the edge, is the choice and, if appropriate, variation of the respective curvature of the elevations or depressions. The curvature may be spherical, and the elevation or depression may correspondingly be formed in the shape of a spherical cap. As an alternative, the curvature may be chosen to be aspherical. Furthermore, in order to ensure the abovementioned aim, it is possible to vary the depth of the recesses or the height of the elevations.

It is evident from the explanations above that the measures presented may be provided alternatively or cumulatively. For practical implementation of the solution mentioned above, a first solution variant provides a diffusing screen which has a transparent basic body with a first surface, the first surface being subdivided into facets, and in the case of which each facet is assigned an elevation or depression with a second surface formed in curved fashion, and in which the vertices S of the elevations or depressions are arranged along a spiral.

The vertex S of the elevation or depression shall be defined as the point of intersection between the normal to the surface of the facet passing through the facet centroid and the curved surface of the elevation or depression.

If the elevation, the radius and/or the depth of the elevation or depression differ in the case of two adjacent facets, then the common edge is generally curved, and edges which assume different geometrical shapes in a plan view result for the depressions.

The arrangement of the vertices S along a spiral produces a multiplicity of irregularly arranged facets which, as desired, create a round light field which, in the case of discharge lamps, has no discolorations in the edge region, and the illumination intensity gradient of which can be predetermined.

The height of the elevations or depressions can be varied across the diffusing screen 3, so that the elevations and depressions turn out to have different heights or depths. This also contributes to the aim of providing a round light field which emerges more or less in soft fashion or in hard fashion.

In a configuration of the diffusing screen 3 illustrated in FIG. 3, the vertices S of the facets 24, 25, 26 are essentially situated on an Archimedes' spiral.

The individual points are obtained by continued removal of a constant arc length L along the spiral from the inside outward. The vertices may be arranged equidistantly from one another. In addition to the equidistant arrangement of the vertices, a variable arc length L is also possible. An arc length L that increases from the inside outward may thus be chosen. Within the diffusing screen, small facets with elevations having a small height or with depressions having a small depth, and hence a small diffusing effect are obtained in this way. Toward the edge, the facets become larger, the height of the elevations or the depth of the depressions becomes larger and the diffusing effect likewise becomes greater. The light field then has a rather small half scattering angle with a very large illumination intensity in the center. In contrast to this, given a constant L, the illumination intensity would be rather plateau-shaped and run out in soft fashion.

The measures mentioned above which can be implemented alternatively and, if appropriate, cumulatively, permit the diffusing screen 3 to be adapted to the respective illumination system, for example the respective reflector, in a diverse manner.

Thus, adaptation to a reflector may be effected through the choice of the type of spiral, the value of the arc length L, but also by variation or constancy of the arc length. These measures make it possible to influence the light field in predetermined regions of the illumination system, to locally amplify or attenuate it, and thus permit the light field to be optimized in a diverse manner.

It is apparent from the explanations above that the solution variants provide the person skilled in the art with a wealth of parameters as to how he can configure and adapt the light field taking account of the illumination system. In this respect, the chosen approach of the different geometrical shapes for the facets permits highly diverse and variable adaptation of the light field to the respective conditions.

By way of example, FIGS. 1 and 2 show further preferred embodiments. FIG. 1 illustrates a first embodiment of the optical arrangement of a stepped lens with an approximately centrically arranged, essentially circular diffusing screen having individual facets that are slightly rotated with respect to one another, and FIG. 2 shows a second embodiment of the optical arrangement of a stepped lens with an approximately centrically arranged, essentially circular diffusing screen having facets which have been offset from their regular position by means of a Monte Carlo method.

It is furthermore the case that a plurality of possibilities which differ in terms of their design are also open for the realization of a light field as desired or a predefined diffusing behavior as desired. In this respect, the solution variants also permit the provision of optimized diffusing screens with regard to the esthetic appearance. By way of example, a rhomboid pattern or the shape of a houndstooth pattern may be used for the facet.

Furthermore, it is also possible within the scope of the invention to use non-coaxial or non-concentric arrangements of the diffusing screen.

List of reference symbols

1 Arrangement
2 Stepped lens
3 Diffusing screen
4 Annular, concentric essentially optically effective surface segments
5 Ditto
6 Ditto
7 Basic body (segment)
8 As 4 to 6
9 Basic body segment of the multipartite arrangement
10 Plane-parallel edge region
11 Optically effective surface
12 Ditto
13 Ditto
14 Planoconvex lens made of solid material
15 Convex-concave stepped lens
16 Radial extent of the optically effective surface segments, width
17 Height of the optically effective surface segments
18 Antireflection layer
19 Antiscratch layer
20 Interference filter layer
21 Antiscratch layer
22 Centric region that diffuses to a-greater extent
23 Marginal region that diffuses to a lesser extent
24 Facet
25 Ditto
26 Ditto

1. An optical arrangement comprising:
a stepped lens, and
a light-diffusing element.

2. The optical arrangement as claimed in claim 1, wherein the light-diffusing element is a diffusing screen arranged only in a central and/or centric region of the stepped lens.

3. The optical arrangement as claimed in claim 1, wherein the light-diffusing element is a diffusing screen that is circular.

4. The optical arrangement as claimed in claim 1, wherein the light diffusing-element is a diffusing screen that is arranged at a light exit area of the stepped lens.

5. The optical arrangement as claimed in claim 2, wherein the light-diffusing element is a diffusing screen that is arranged at a light entry area of the stepped lens.

6. The optical arrangement as claimed in claim 1, wherein the light-diffusing element comprises a first diffusing screen arranged at a light entry area of the stepped lens and a second diffusing screen arranged at a light exit area of the stepped lens.

7. The optical arrangement as claimed in claim 1, wherein the light-diffusing element has a first region that diffuses to a greater extent centrically and a second region that diffuses to a lesser extent marginally.

8. The optical arrangement as claimed in claim 1, wherein the light diffusing-element is a diffusing screen that is produced in matted fashion and/or by hot-forming.

9. The optical arrangement as claimed in claim 1, wherein stepped lens and/or the light diffusing-element comprise glass.

10. The optical arrangement as claimed in claim 1, wherein stepped lens and/or of the light diffusing-element comprise glass-ceramic material.

11. The optical arrangement as claimed in claim 1, wherein the stepped lens and the light-diffusing element are formed in one piece.

12. The optical arrangement as claimed in claim 1, wherein the stepped lens is an aspherical lens.

13. The optical arrangement as claimed in claim 1, wherein the stepped lens is a spherical lens.

14. The optical arrangement as claimed in claim 1, wherein the stepped lens has a basic body with an essentially planar surface.

15. The optical arrangement as claimed in claim 1, wherein the stepped lens has an optically beam-shapingly effective basic body with an essentially concave spherical surface or an aspherical surface.

16. The optical arrangement as claimed in claim 1, wherein the stepped lens has an optically beam-shapingly effective basic body with an essentially convex spherical surface or an aspherical surface.

17. The optical arrangement as claimed in claim 1, wherein the stepped lens has one or more essentially annular, optically effective surfaces that are configured as circle-arc segments.

18. The optical arrangement as claimed in claim 1, wherein the stepped lens has one or more essentially annular, optically effective surfaces that are formed in the shape of cone envelopes.

19. The optical arrangement as claimed in claim 1, wherein the stepped lens has one or more essentially annular, optically effective surfaces that are shaped so that an approximately planar wave with phase fronts perpendicular to an optical axis of the stepped lens is combined at a real focal point or is converted into a spherical wave whose midpoint appears to lie at a virtual focal point.

20. The optical arrangement as claimed in claim 1, wherein the stepped lens and/or the light diffusing-element comprises plastic.

21. The optical arrangement as claimed in claim 1, wherein the stepped lens and the light diffusing-element comprise a plurality of elements.

22. The optical arrangement as claimed in claim 21, wherein the light diffusing-element is made of glass and the stepped lens is made of plastic.

23. The optical arrangement as claimed in claim 1, wherein the stepped lens comprises a material with a first dispersion behavior and wherein the optical arrangement further comprises a second stepped lens with an opposite refractive power to the stepped lens, and wherein the second stepped lens comprises a material with a second dispersion behavior so that chromatic aberrations are reduced.

24. The optical arrangement as claimed in claim 1, wherein the stepped lens is an embossed plastic lens with an optical path length difference at a step of less than about 1000 optical wavelengths.

25. The optical arrangement as claimed in claim 1, wherein the stepped lens formed or arranged on a first side and the light diffusing-element is formed or arranged on a side opposite to the first side.

26. The optical arrangement as claimed in claim 1, further comprising one or more annular segments arranged around a central circular segment of the stepped lens, wherein the one or more annular segments and the central circular segment essentially have the same radial extent.

27. The optical arrangement as claimed in claim 1, wherein the stepped lens comprises at least two adjacent annular segments having essentially the same height.

28. The optical arrangement as claimed in claim 1, further comprising at least that one surface for facing a light source, wherein the at least one surface comprises thermally prestressed glass.

29. The optical arrangement as claimed in claim 1, wherein the stepped lens and/or the light diffusing-element are/is formed as a filter selected from the group consisting of a UV filter, an IR filter, a colored bandpass filter, and a conversion filter.

30. The optical arrangement as claimed in claim 1, wherein the stepped lens and/or the diffusing screen are coated with a mechanical antiscratch layer and/or an antireflection layer.

31. A diffusing screen for an optical arrangement, comprising:
a first surface being subdivided into a plurality of facets, each facet in the plurality of facets being assigned an elevation or depression with a second surface formed in curved fashion, wherein each facet in the plurality of facets assume different geometrical shapes.

32. The diffusing screen as claimed in claim 31, wherein each facet in the plurality of facets has a polygonal edge contour.

33. The diffusing screen as claimed in claim 31, wherein each facet in the plurality of facets has a different surface area.

34. The diffusing screen as claimed in claim 31, wherein each facet in the plurality of facets assume a shape selected from the group consisting of a triangle, a quadrangle, a pentagon, a hexagon, and a heptagon.

35. The diffusing screen as claimed in claim 31, wherein each facet in the plurality of facets has a different orientations.

36. The diffusing screen as claimed in claim 31, wherein the elevation or depressions is formed in the shape of a spherical cap.

37. The diffusing screen as claimed in claim 31, wherein the plurality of facets have elevations and/or the depressions with a height that are different.

38. The diffusing screen as claimed in claim 31, wherein the elevation or depressions of each facet in the plurality of facets has a vertex, and wherein the plurality of facets are arranged so that the vertices are along a spiral.

39. The diffusing screen as claimed in claim 38, wherein the spiral is an Archimedes' spiral.

40. The diffusing screen as claimed in claim 38, wherein the vertices of two adjacent facets have an arc length therebetween along the spiral that is almost equidistant.

41. The diffusing screen as claimed in claim 38, wherein the vertices of two adjacent facets have an arc length therebetween along the spiral that is variable.

42. The diffusing screen as claimed in claim 38, wherein the plurality of facets have elevations and/or the depressions with a height that are different.

43. The diffusing screen as claimed in claim 31, wherein each facet in the plurality of facets are rotated relative to one another.

44. The diffusing screen as claimed in claim 31, wherein each facet in the plurality of facets are offset by a Monte Carlo method.

45. The diffusing screen as claimed in claim 31, further comprising a defined granularity and a central region, wherein the defined granularity is finer in the central region and coarser with increasing distance from the central region.
